(19) United States
(12) Patent Application Publication
(10) Pub. No.: US 2011/0052272 A1
(43) Pub. Date: Mar. 3, 2011

(54) DEVELOPER MATERIAL CARRYING BODY, DEVELOPING UNIT, AND IMAGE FORMING APPARATUS

(75) Inventor: Takaaki EBE, Tokyo (JP)

(73) Assignee: Oki Data Corporation, Tokyo (JP)

(21) Appl. No.: 12/871,998

(22) Filed: Aug. 31, 2010

(30) Foreign Application Priority Data
Aug. 31, 2009 (JP) 2009-200580

(51) Int. Cl. G03G 15/08

(52) U.S. Cl. 399/279

(57) ABSTRACT

A developer material carrying body rotates in contact with an image carrying body on which an electrostatic latent image is formed. The developer material carrying body deposits a developer material to the electrostatic latent image. The developer material carrying body includes a surface having a surface potential (Vo) 0.15 seconds after having been charged, and a relaxation time (τ) required for the surface potential changes to change from Vo to Vo/e. The surface potential and relaxation time are related such that 2.0≦Vo≦10 and 0<τ<0.20.

### BACKGROUND OF THE INVENTION

1. Field of the Invention

The present invention relates a developer material carrying body on which a layer of a developer material is formed and which contacts an image carrying body, a developing unit that incorporates the developer material carrying body and forms a toner image, and an image forming apparatus that incorporates the developing unit and forms an image on a sheet of medium in accordance with image data, and outputs the printed sheet of medium.

2. Description of the Related Art

Image forming apparatus such as printers, fax machines, and electrophotographic color recording apparatus perform an electrophotographic process. A charging roller uniformly charges the surface of a photoconductive drum. An exposing unit illuminates the charged surface of the photoconductive drum to form an electrophotographic latent image in accordance with image information. A developer material carrying body deposits a developer material or toner to the photoconductive drum to develop the electrostatic latent image into a toner image.

Defects of the developer carrying body may cause belt-shaped unevenness in density and toner fog in printed images. Thus, some developer material carrying bodies include a urethane layer formed on the surface of the developer carrying body which has undergone surface treatment in an isocyanate solution, thereby improving the long term storage stability of the developer material carrying body and alleviating belt-shaped unevenness in density and toner fog in printed images.

The above-described developer material carrying body has a large electrical capacitance in the vicinity of its surface, so that when continuous printing is performed, charges tend to be stored on the surface of the developer material carrying body.

The surface area of the developer material carrying body exposed to the air outside of the developing unit tends to attract moisture from the outside air, the moisture dissipating the charges on the developer material carrying body. The surface of the developer material carrying body in contact with the bulk of toner attracts some moisture from the toner but the charges on the developer carrying body are difficult to be dissipated. As a result, if printing is performed to print an image on a sheet of medium after a certain period of time during which the image forming apparatus remains inoperative, the amount of charge on the surface in contact with the outside air greatly differs from that on the surface of the developer material carrying body in contact with the bulk of toner. The large difference in the amount of charge between surface areas of the developer material carrying body may cause belt-shaped unevenness in density and toner fog in printed images.

### SUMMARY OF THE INVENTION

The present invention was made to solve the above-described drawbacks.

An object of the invention is to provide a developer carrying body, a developing unit, and an image forming apparatus in which belt-shaped unevenness in density and toner fog in printed image are difficult to occur.

A developer material carrying body rotates in contact with an image carrying body on which an electrostatic latent image is formed. The developer material carrying body deposits a developer material to the electrostatic latent image formed on the image carrying body. The developer material carrying body includes a surface having a surface potential (Vo) 0.15 seconds after charging, and a relaxation time (τ) required for the surface potential to change from Vo to Vo/e. The surface potential and relaxation time are related that 2.0≦Vo≦10 and 0<τ<0.20.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates the configuration of an image forming apparatus of the invention;

FIG. 2 illustrates the configuration of a developing sub unit;

FIG. 3 illustrates the configuration in the vicinity of a developing roller of the developing sub unit;

FIGS. 4 and 5 illustrate the measurement of a resistance of the developing roller;

FIG. 6 illustrates the measurement of dielectric relaxation of the surface potential of the developing roller;

FIG. 7 illustrates the measurement of dielectric relaxation of the surface potential of the developing roller;

FIG. 8 illustrates changes in the resistance and surface potential of the developing roller when the dielectric characteristic of the developing roller is high;

FIG. 9A illustrates changes in the resistance and surface potential of the developing roller when the dielectric characteristic of the developing roller is low;

FIG. 9B illustrates a test pattern (2×2 dots, every 2 dots spacing);

FIG. 10 illustrates Table 1 that lists test results of belt-shaped unevenness in density and toner fog of the developing roller;

FIG. 11 is a block diagram illustrating the configuration of the image forming apparatus according to the invention;

FIG. 12 illustrates Table 2 that shows test results of belt-shaped unevenness in density and toner fog of the developing roller.

### DETAILED DESCRIPTION OF THE INVENTION

Preferred embodiments of a developer material carrying body, a developing unit, and an image forming apparatus will now be described with reference to the accompanying drawings. The developer material carrying body, developing unit, and image forming apparatus according to the present invention are not limited to those described below and may be modified as required without departing from the scope of the invention.

### First Embodiment

A developer material carrying body according to a first embodiment has features of 2.0≦Vo≦10 and 0<τ≦0.20, where Vo (volts) is a surface potential of the developer material carrying body 0.15 seconds after the surface of the developer material carrying body is charged from a distance of 1.0 mm at a voltage of 6,000 volts, τ (seconds) is a relaxation time required for the surface potential to change from Vo to Vo/e, and e is the base of natural logarithm which is equal to 2.71828. Thus, even if printing is performed after a certain period of time during which the image forming apparatus remains inoperative, an image can still be printed normally while the differences in resistance and surface potential between a toner-receiving surface in contact with the bulk toner and an exposed surface in contact with the outside air are relatively small.

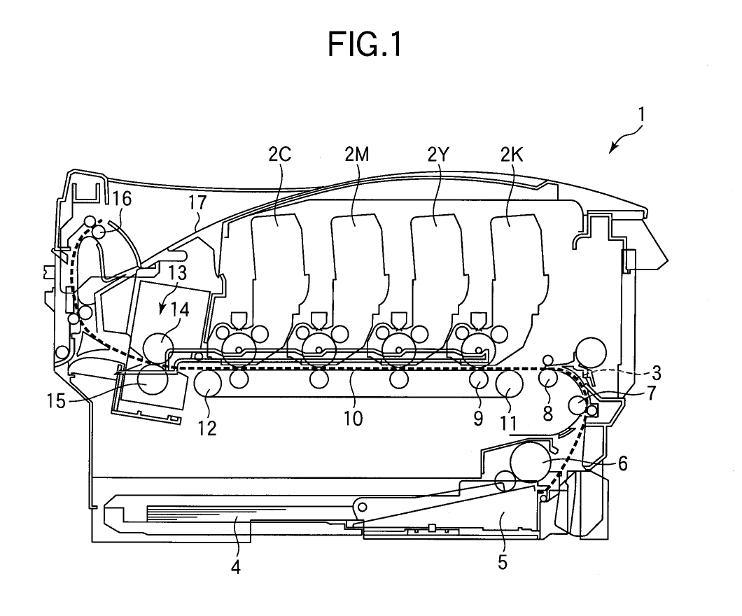

An image forming apparatus 1 according to the first embodiment will now be described. FIG. 1 illustrates the configuration of the image forming apparatus 1. A developing unit 2 includes developing sub units 2C, 2M, 2Y, and 2K configured to print cyan, magenta, yellow, and black images, respectively, on a recording medium 4 in accordance with image information. A paper transport path 3 is generally in the shape of an elongate “S” and runs starting from a paper cassette 5 and ending at a stacker 17.

The paper transport path 3 runs from a paper cassette 15 that holds a stack of recording medium 4 through a hopping roller 6, registry rollers 7 and 8, an idle roller 11, transfer rollers 9, a transfer belt 10, a drive roller 12, a fixing unit 13, and a discharging roller 16 to the stacker 17. The respective structural elements along the paper transport path 3 will be described in detail with reference to FIG. 1.

The recording medium 4 is a print medium having a size suitable for printing a monochrome image or a color image thereon, and includes recycled paper, glossy paper, bond paper, and transparency. The paper cassette 5 holds a stack of the recording medium 4 therein, and supplies the recording medium 4 during printing. The paper cassette 5 is removably attached to the image forming apparatus 1. The hopping roller 6 rotates in pressure contact with the top page of the stack of the recording medium 4 to feed the recording medium 4 on a page-by-page basis to the registry rollers 7 and 8. The registry rollers 7 and 8 correct skew of the recording medium 4 before transporting the recording medium 4 to the transfer belt 10.

The transfer roller 9 is located under the photoconductive drum 21 so that the recording medium 4 is sandwiched between the photoconductive drum 21 and the transfer roller 9. The toner image is transferred from the photoconductive drum 21 onto the recording medium 4 as the recording medium 4 passes through a gap between the photoconductive drum 21 and the transfer roller 9. The transfer roller 9 includes a foamed resilient body. The transfer belt 10 is an endless belt for transporting the recording medium 4 through the developing sub units 2C, 2M, 2Y, and 2K in sequence so that toner images are transferred in register onto the recording medium 4 carried on the transfer belt 10. The idle roller 11 stabilizes the driving of the transfer belt 10, and the drive roller 12 drives the transfer belt 10 to run. The transfer belt 10 is disposed about the idle roller 11 and drive roller 12 which apply a predetermined amount of tension on the transfer belt 10. The idle roller 11 and drive roller 12 are formed of a high friction material. A drive source (not shown) drives the idle roller 11 and drive roller 12 in rotation, thereby causing the transfer belt 10 to run.

The fixing unit 13 includes a fixing roller 14 and a pressure roller 15. The fixing roller 14 and pressure roller 15 are positioned to hold the recording medium 4 in a sandwiched relation therebetween when the recording medium 4 transported on the transfer belt 10 enters a gap between the fixing roller 14 and the pressure roller 15. As the recording medium 4 passes through the gap, the toner image on the recording medium 4 is fixed under pressure and heat. Specifically, the toner image on the recording medium 4 is fused by heat generated by a heat source such as a halogen lamp disposed in the fixing roller 14. The discharging roller 16 discharges the recording medium 4 onto the stacker 17 after fixing. The stacker 17 receives and holds pages of the recording medium 4 on which images have been printed.

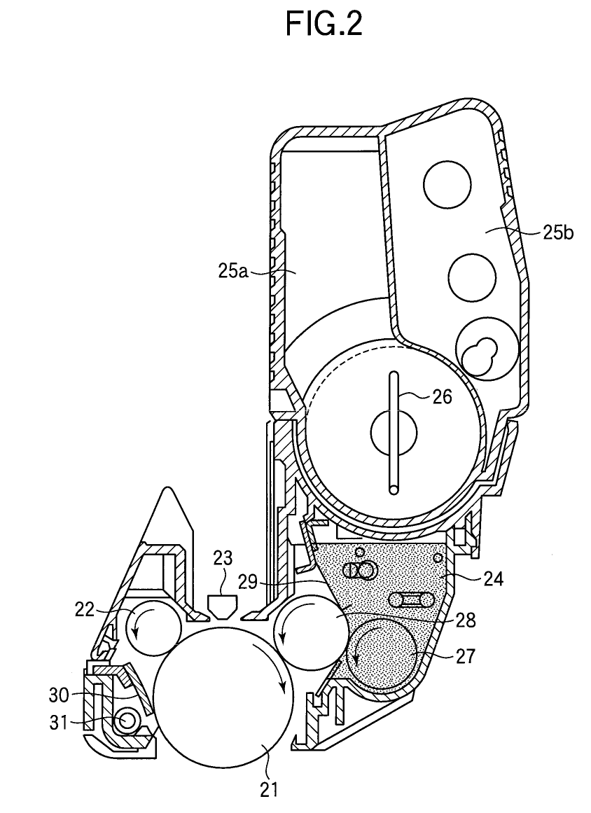

A detailed description will be given of the developing sub units 2C, 2M, 2Y, and 2K which print toner images of corresponding colors, i.e., cyan, magenta, yellow, and black, in accordance with the image information. FIG. 2 illustrates the configuration of the developing sub unit 2C. Each of the developing sub units 2C, 2M, 2Y, and 2K may be substantially identical; for simplicity only the operation of the developing sub unit 2C for forming cyan images will be described, it being understood that the other developing units 2M, 2Y, and 2K may work in a similar fashion.

A charging roller 22 uniformly charges the surface of the photoconductive drum 21. An exposing unit 23 illuminates the charged surface of the photoconductive drum 21 to form an electrostatic latent image in accordance with the image information. A toner cartridge holds the developer material or toner 24 therein. An agitating member 26 agitates the toner 24 in a toner cartridge 25. A toner supplying roller 27 supplies the toner 24 to a developer material carrying body or a developing roller 28. The developing roller 28 deposits the toner 24 to the electrostatic latent image formed on the photoconductive drum 21. A developing blade 29 forms a thin layer of the toner 24 on the developing roller 28. A cleaning blade 30 scrapes the toner 24 remaining on the photoconductive drum 21 after transfer of the toner image onto the recording medium 4. A cleaning spiral 31 transports the toner scraped off the photoconductive drum 21. The toner 24 is then collected into a waste toner chamber 25b via a path (not shown). The developing sub unit 2C is removably attached to the image forming apparatus 1. The respective structural members of the developing sub unit 2C will be described in detail with reference to FIG. 2.

The photoconductive drum 21 is a generally cylindrical, rotatable member, and includes an aluminum core tube having an outer diameter of 30 mm and a thickness of 0.75 mm, and a charge generation layer and a charge transport layer formed thereon. The charge transport layer is formed of polycarbonate which functions as a binder resin and has a thickness in the range of 5 to 30 μm. Under the above-described conditions, the circumferential speed of the photoconductive drum 21 is 0.178 m/sec. The charging roller 22 includes a metal shaft covered with a semi-conductive rubber such as silicone. The charging roller 22 rotates at a circumferential speed of 0.178 m/sec in contact with the photoconductive drum 21 under a certain pressure, applying a positive voltage or a negative voltage on the surface of the photoconductive drum 21 to uniformly charge the surface of the photoconductive drum 21.

The exposing unit 23 is located above the photoconductive drum 21 and irradiates the charged surface of the photoconductive drum 21 with light in accordance with the image information to form an electrostatic latent image on the photoconductive drum 21. The exposing unit 23 includes a plurality of LEDs, lens arrays, and LED driving devices. The toner 24 is pulverized one component non-magnetic developer material which is deposited to the electrostatic latent image to form a toner image or a visible image. The toner has a volume mean particle diameter of 5.7 μm, a blow-off charge of −43 μC/g, and a roundness of 0.950. The toner cartridge 25 is in the shape of a rectangle combined with a semi-cylinder and generally extends in its longitudinal direction substantially perpendicular to a direction of travel of the recording medium 4. The toner cartridge 25 is detachably attached to the image forming apparatus 1, and is replaced when the toner cartridge 25 runs out of the toner 24. The agitator member 26 is formed of a hard material in the shape of a long, cylindrical rod having a substantially circular cross section or a long blade having a substantially rectangular cross section, is rotatably supported in the toner cartridge 25, and agitates the toner 24 when rotated.

The toner supplying roller 27 rotates in contact with the developing roller 28, thereby supplying the toner 24 to the developing roller 28. The toner supplying roller 27 includes a metal shaft of, for example, SUS having an outer diameter of 6 mm covered with a foamed rubber material, for example, silicon sponge having an Asker F hardness in the range of 50-60° and a thickness of 4.75 mm. Thus, the toner supplying roller 27 has an outer diameter of 15.5 mm, and rotates at a circumferential speed of 0.138 m/sec. The silicon sponge is shaped into a cylinder by extruding, for example, a silicone rubber compound (non-vulcanized) and is then heated for vulcanizing and foaming. Foaming the silicone rubber compound produces fine holes or cells having a diameter in a range of 200-500 μm, formed in the surface of the toner supplying roller 27. The size of a nip of the toner supplying roller 27 in contact with the developing roller 28 is, for example, 1 mm.

The developing roller 28 or a developer material carrying body rotates in contact with the surface of the photoconductive drum 21 under a certain pressure. The developing roller 28 plays an important role in the present invention, and will be described in detail. The developing roller 28 supplies the toner 24 to the photoconductive drum 21 while rotating, thereby developing an electrostatic latent image formed on the surface of the photoconductive drum 21 into a toner image. The developing roller 28 includes an SUS shaft having an outer diameter 10 mm and an elastic layer formed of polyether urethane having a hardness of Asker C 76°, the SUS shaft being covered with the elastic layer.

Specifically, the elastic layer employs polyether polyol and aliphatic isocyanate as a base polymer. Carbon black, for example, acetylene black or ketjen black is added as an electrically conductive material to the elastic layer for adjusting the electrical resistance of the elastic layer (the resistance between the shaft and the surface of the developing roller). The carbon black in an amount of 5 weight parts or less based on 100 weight parts urethane is added to the base polymer. The elastic layer has an electrical resistance of, for example, 1×10⁶Ω, and preferably in the range of 1×10⁵ to 11×10⁷Ω. The developing roller 28 includes a metal shaft of SUS having a diameter of 10 mm covered with a layer of urethane having a thickness of 2.95 mm, and therefore has an outer diameter of 15.9 mm. The surface of developer roller 28 is subjected to coarse polishing and then finishing polishing to a predetermined outer diameter. The surface roughness of the developing roller 28 after polishing has a ten-point height of irregularities Rz in the range of 2 to 6 μm under a test according to JISB 0601-1994. The developing roller rotates at a circumferential speed of 0.212 m/sec.

For the developing roller 28 to carry the toner 24 thereon effectively, the elastic layer of the developing roller 28 is subjected to an isocyanate treatment, thereby forming a surface layer on the developing roller 28. Isocyanate treatment is a treatment in which the surface of the elastic layer of the developing roller 28 is immersed in an isocyanate solution for 30 seconds and is then heated in an oven of 100° C. for 10 hours to dry. Isocyanate solution is a solution obtained by dissolving 20 weight parts isocyanate compound based on 100 weight parts acetic ether in an organic solvent such as acetic ether, and then carbon black, for example, acetylene black or ketjen black is added to the solution.

Isocyanate compounds include 4,4′-Diphenylmethanediisocyanate, p-Phenylene diisocyanate and 2,6-tolylene diisocyanate. If the surface resistance of the developing roller 28, which has undergone an isocyanate treatment, is increased after an elastic layer of urethane is dried, the charging characteristic of the toner 24 is improved. For this reason, the surface of the developing roller 28 is wiped (IP cleaning) using, for example, a cloth that has been immersed in isopropyl alcohol (organic solvent), thereby impregnating the isopropyl alcohol into the surface of the elastic layer. The above-described treatment causes the carbon chain in the surface of the elastic layer to contract or expand, uniformly improving the charging characteristic of the surface of the developing roller 28.

The developing blade 29 has its free end portion in slight contact with the surface of the developing roller 28, and scrapes excess toner 24 from the surface of the developing roller 28, thereby restricting the thickness of a layer of the toner 24 formed on the developing roller 28. The developing blade 29 is a plate-like resilient member formed from stainless steel. A cleaning blade 30 scrapes off the toner 24 remaining on the photoconductive drum 21 after transfer of the toner image onto the recording medium 4. The cleaning blade 30 is in the shape of a plate and is disposed upstream of the charging roller 22 with respect to rotation of photoconductive drum 21, and is in pressure contact with the surface of the photoconductive drum 21 under a predetermined pressure. The toner 24 scraped by the cleaning blade 30 off the photoconductive drum 21 is transported by the cleaning spiral 31 to the far end of the waste toner chamber 25b. The cleaning spiral 31 prevents the toner 24 from becoming caked in the vicinity of the entrance of the waste toner chamber 25b. The waste toner chamber 25b has a generally rectangular cross section, and extends in a direction generally perpendicular to a direction in which the recording medium 4 is transported. The waste toner chamber 25b extends generally in parallel to a fresh toner chamber 25a.

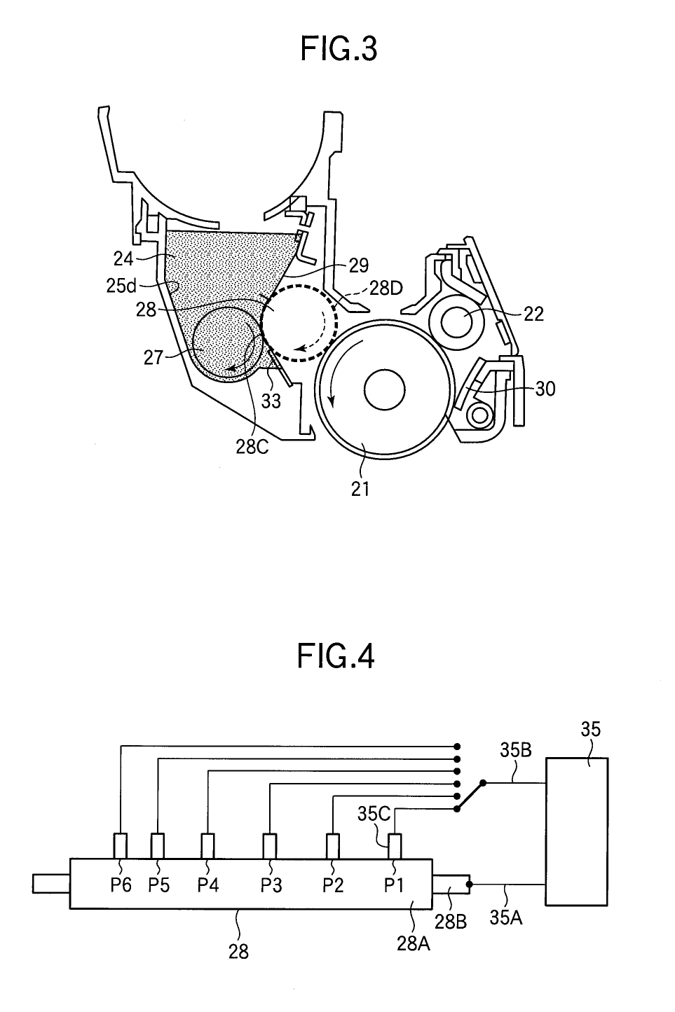

The belt-shaped unevenness in density in the images printed on the recording medium 4, caused by the developing roller 28, will be described. FIG. 3 illustrates the configuration in the vicinity of the developing roller 28 of the developing sub unit 2C.

The developing roller 28 rotates in contact with the photoconductive drum 21 under a predetermined pressure, thereby supplying the toner 24 on the developing roller 28 to the electrostatic latent image formed on the photoconductive drum 21. The toner 24 in the region bounded by the developing blade 29, the developing roller 28, a toner leakage-preventing seal 33, and a wall 25d of the toner cartridge 25, is bulk toner. The developing roller 28 has a toner-receiving surface 28C (thick solid line in FIG. 3) in contact with the bulk toner and an exposed surface 28D (thick dotted line in FIG. 3) in contact with outside air. The toner 24 is formed into a thin layer on the surface of the developing roller 28 in a region bounded by the developing blade 29, the photoconductive drum 21 and toner leakage preventing seal 33. If the image forming apparatus 1 remains inoperative longer than a certain period of time, the amounts of charge on the toner are different for the toner-receiving surface 28C on which no thin layer of toner is formed and the exposed surface 28D on which the thin layer of toner is formed. In other words, the amounts of charge on the toner-receiving surface 28C and the exposed surface 28D are different.

Specifically, the charges stored on the exposed surface 28D tend to be dissipated since the developing roller 28 absorbs moisture form the outside air. The charges stored on the toner-receiving surface 28C are difficult to be dissipated though the developing roller 28 absorbs some moisture from the toner 24. As a result, if an image is formed on a sheet of medium after a certain period of time during which the image forming apparatus remains inoperative, the amount of charge on the surface in contact with the outside air greatly differs from that on the surface in contact with the bulk of toner. The difference in the amount of charge causes the variation in the density of toner image formed on the photoconductive drum 21, the variation in density appearing in the shape of a belt during development of an electrostatic latent image. This type of variation in the density of the toner image is referred to “belt-shaped unevenness in density” in this specification.

If the charges are discharged from the developing roller 28, the surface potential of the developing roller 28 decrease. Measurement of the resistance and surface potential on the developing roller 28 provides information on the charging characteristic of the developing roller 28. The resistance and surface potential of the developing roller 28 were measured as follows:

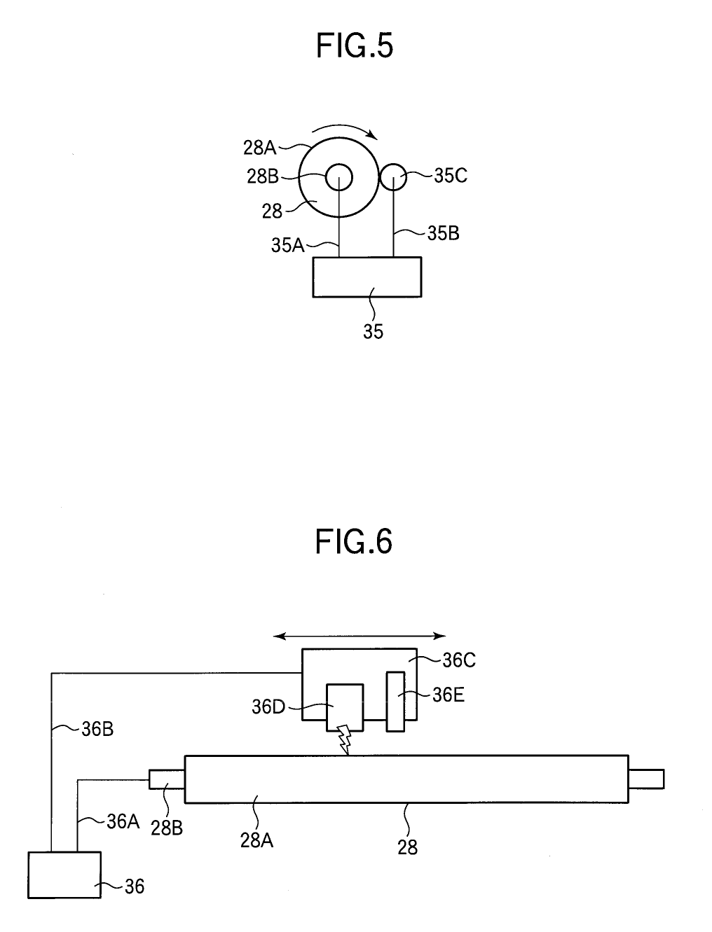

The measurement of the electrical resistance of the developing roller 28 will be described. FIGS. 4 and 5 illustrate the measurement of the resistance of the developing roller 28.

The resistance of the developing roller 28 can be determined in terms of the resistance between a core 28B and surface layer 28A of the developing roller 28. The model 4339B high resistance meter available from HEWLETT PACKARD was used as a resistance measuring meter 35. Specifically, a test lead 35A of the resistance measuring meter 35 is connected to the core 28B of the developing roller 28, and a measuring port 35 connected to the test lead 35B is pressed against the surface layer 28A under a pressing force of 20 gf. The measurement was made while rotating the developing roller 28. The measuring port is a ball bearing formed of SUS in the shape of a cylinder having a diameter of 6.0 mm and a length of 2.0 mm. The ball bearing is in contact with the developing roller 28 so that the developing roller 28 contacts across the length of 2.0 mm of the ball bearing. Six of the measuring ports 35C are disposed at measurement points P1-P6 on the surface layer 28A along the developing roller 28. The measurements of resistance were made at 100 points while the developing roller 28 makes one complete rotation, and the resistance is determined by taking an average of the resistance values at the 600 points. The model 4339B high resistance meter applies a voltage of 1,000 V to the core 28B of the developing roller 28.

The measurement of dielectric relaxation of the surface potential of the developing roller 28 will now be described. FIG. 6 illustrates the measurement of dielectric relaxation of the surface potential of the developing roller 28.

The dielectric relaxation of the developing roller 28 can be determined by measuring the surface potential of the surface layer 28A of the developing roller 28 over time, and is measured using an electrostatic measurement system or dielectric relaxation measurement apparatus 36, for example, the model DRA-2000L commercially available from QUALITY ENGINEERING ASSOCIATES. Specifically, the or dielectric relaxation measurement apparatus 36 has a test lead 36A connected to the core 28B of the developing roller 28 and a test lead 36B connected to a measuring port 36C. The measuring port 36C is positioned very close to the surface layer 28A of the developing roller 28. The measuring port 36C includes a corona discharger 36D and a surface potential meter 36E. The tip portion of the corona discharger 36D is close to the surface layer 28A of the measuring port 36C. The measuring port 36C is positioned at a desired position on the developing roller 28, and is driven so that the distance between the tip of the discharger 36D and the surface layer 28A of the developing roller 28 is equal to 1 mm. Subsequently, a voltage of 6,000 V is applied across the tip of the corona discharger 36D and the surface layer 28A of the developing roller 28 to charge the developing roller 28, while scanning the probe of a surface potential meter 36E for 0.15 seconds. The voltages or potentials are measured over a predetermined period of time.

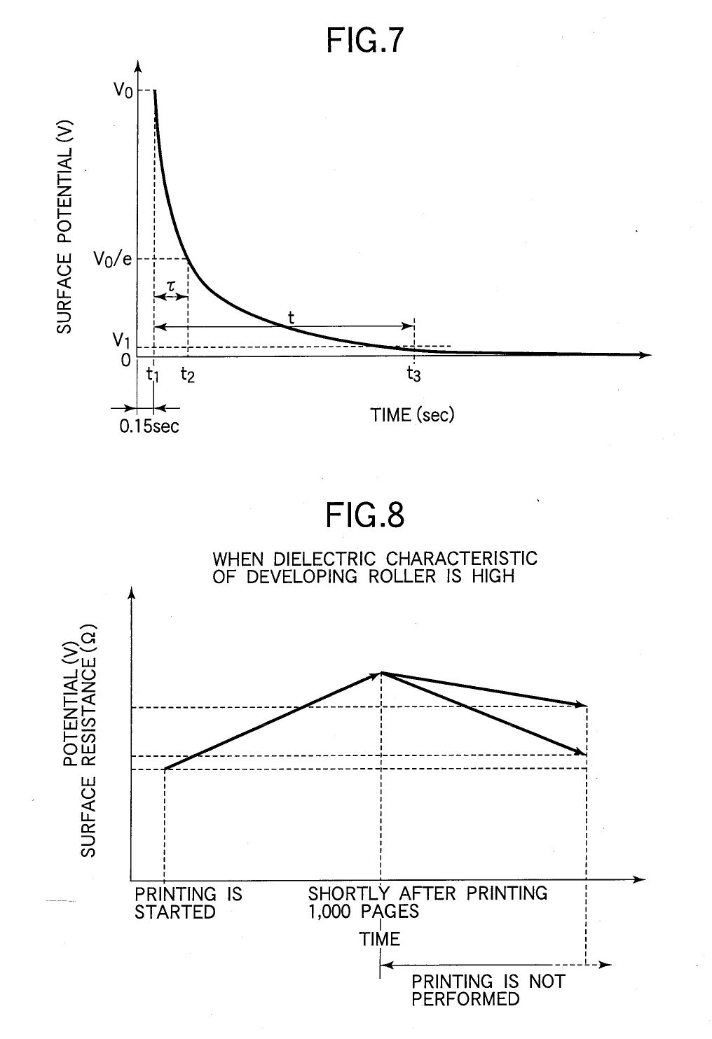

The dielectric relaxation of the surface potential of the developing roller 28 will be described in detail. FIG. 7 illustrates the measurement of the dielectric relaxation of the surface potential of the developing roller 28.

A voltage of 6,000 V is applied across the tip of the corona discharger 36D and the surface layer 28A of the developing roller 28, thereby charging the surface of the developing roller 28. Assume that Vo (volts) is the surface potential of the developing roller 28 shortly after the probe of the surface potential meter 36E scans the corona discharged area for 0.15 seconds, and τ (seconds) is the relaxation time required for the surface potential of the developing roller 28 to decrease to Vo/e (volts) where “e” is the base of natural logarithm which is equal to 2.71828. Referring to FIG. 7, there is a relation in which the relaxation time τ=t2−t1. Likewise, V1 is the decay saturation voltage of the surface potential of the developing roller 28 and is close to zero volts. Time “t” is a decay saturation time or the time required for the surface potential to reach V1. The value of “t” is given by t3−t1, where t3 is a time at which the surface potential reaches V1 and t2 is a time at which the surface potential reaches Vo/e.

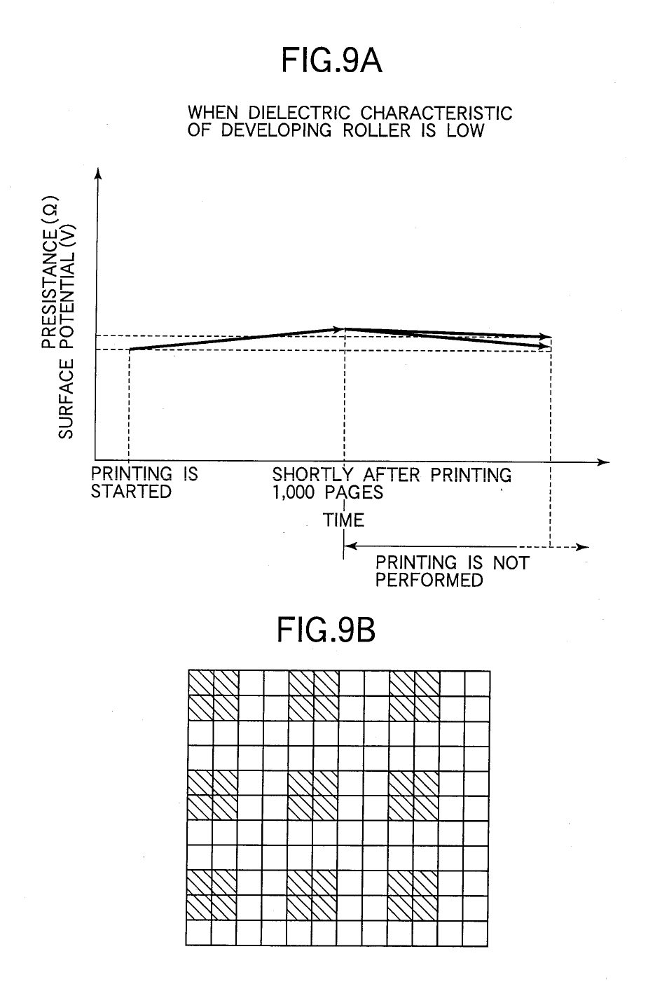

A description will be given of influences of the dielectric characteristic of the developing roller 28 on the resistance and surface potential of the developing roller 28. FIG. 8 illustrates changes in the resistance and surface potential of the developing roller 28 when the dielectric characteristic of the developing roller 28 is high. FIG. 9A illustrates changes in the resistance and surface potential of the developing roller 28 when the dielectric characteristic of the developing roller 28 is low. FIG. 9B illustrates a test pattern (2×2 dots, every 2 dots spacing).

The dielectric characteristic of the developing roller 28 is low if the dielectric constant in the vicinity of the surface of the developing roller 28 in contact with the photoconductive drum 21 is low. The dielectric characteristic of the developing roller 28 is high if the dielectric constant in the vicinity of the surface of the developing roller 28 in contact with the photoconductive drum 21 is high.

If the dielectric characteristic of the developing roller 28 is low, there are not a significant difference in resistance and a significant difference in surface potential between the toner-receiving surface 28C and the exposed surface 28D. For this reason, even if printing is performed to print an image on a sheet of recording medium 4 after a certain period of time during which the image forming apparatus remains inoperative, the belt-shaped unevenness in density is difficult to occur. As a result, printed images have good image quality. A description will be given of influences of the dielectric characteristic of the developing roller 28 on the resistance and surface potential of the developing roller 28 for two cases: high dielectric characteristic and low dielectric characteristic.

Influences of the dielectric characteristic on the resistance and surface potential when the dielectric characteristic is high will be described with reference to FIG. 8. If continuous printing is performed, the developing roller 28 will be heated so that the resistance and surface potential of the developing roller 28 increase. After printing, the resistance and surface potential of the developing roller 28 will gradually decrease. However, as described above with reference to FIG. 3, the charging characteristic is different for the exposed surface 28D of the developing roller 28 and the toner-receiving surface 28C of the developing roller 28. For this reason, the resistance and surface potential decrease at different rates for the exposed surface 28D and the toner-receiving surface 28C. More specifically, the resistance and surface potential decrease more slowly for the exposed surface 28D than for the toner-receiving surface 28C. The exposed surface 28D is in contact with the outside air and absorbs moisture mainly from the air, so that the charges stored on the developing roller 28 tends to be dissipated. On the hand, the charges on the developing roller 28 are difficult to be dissipated through the toner-receiving surface 28C though the toner-receiving surface 28C absorbs some moisture from the toner 24. Thus, if printing is performed to print an image on a sheet of recording medium 4 after a certain period of time during which the image forming apparatus remains inoperative, the printing will be performed with large differences in resistance and surface potential between the toner-receiving surface 28C and the exposed surface 28D. As a result, belt-shaped unevenness in density occurs in the image printed on the recording medium 4, impairing the quality of printed images.

Influences of the dielectric characteristic on the resistance and surface potential when the dielectric characteristic is low will be described with reference to FIG. 9A. If continuous printing is performed, the developing roller 28 will be heated so that the resistance and surface potential of the developing roller 28 increase. Since the dielectric characteristic is low, the resistance and surface potential will not increase significantly. After printing, the resistance and surface potential of the developing roller 28 will gradually decrease. The resistance and surface potential of the toner-receiving surface 28C decrease at a lower speed than those of the exposed surface 28D. Since the resistance and surface potential did not increase significantly during printing, the differences in resistance and surface potential between the toner-receiving surface 28C and the exposed surface 28D are small. Thus, even if printing is performed to print an image on a sheet of medium after a certain period of time during which the image forming apparatus remains inoperative, image data can be transferred onto the recording medium 4 with a small difference in the resistance and surface potential between the exposed surface 28D in contact with the outside air and the toner-receiving surface 28C in contact with the bulk toner, thereby alleviating belt-shaped unevenness in density and toner fog in printed images.

As described above, the resistance and surface potential of the developing roller 28 greatly depend on the dielectric characteristics. In order to minimize the fluctuations of the resistance and surface potential of the developing roller 28, the dielectric characteristic of the developing roller 28 needs to be low.

If the differences in the resistance and surface potential between the toner-receiving surface 28C and the exposed surface 28D of the developing roller 28 are large, belt-shaped unevenness in density occurs in the image printed on the recording medium 4. Toner fog was investigated which will appear on a printed page together with belt-shaped unevenness in density.

Toner fog is a phenomenon in which toner adheres to the surface of the photoconductive drum 21 due to the fact that the toner is overcharged when the resistance of the developing roller 28 increases above a certain limit. Toner fog was evaluated as follows: A test pattern having an area density of 0% (i.e., no bit map data) is printed on a recording medium 4. Area density is the ratio of a total printable area of the recording medium 4 to a total area of the recording medium in which toner is actually present. A piece of mending tape is pressed to an area on the photoconductive drum 21 across a developing point and a transfer point and is then peeled off the photoconductive drum 21. The peeled piece of mending tape and a fresh, unused piece of mending tape are pressed on excellent white paper available from OKI DATA Inc., and subsequently the color difference ΔE is measured. If toner fog occurs on the surface of the photoconductive drum 21, deposition of the toner on the mending tape would be noted.

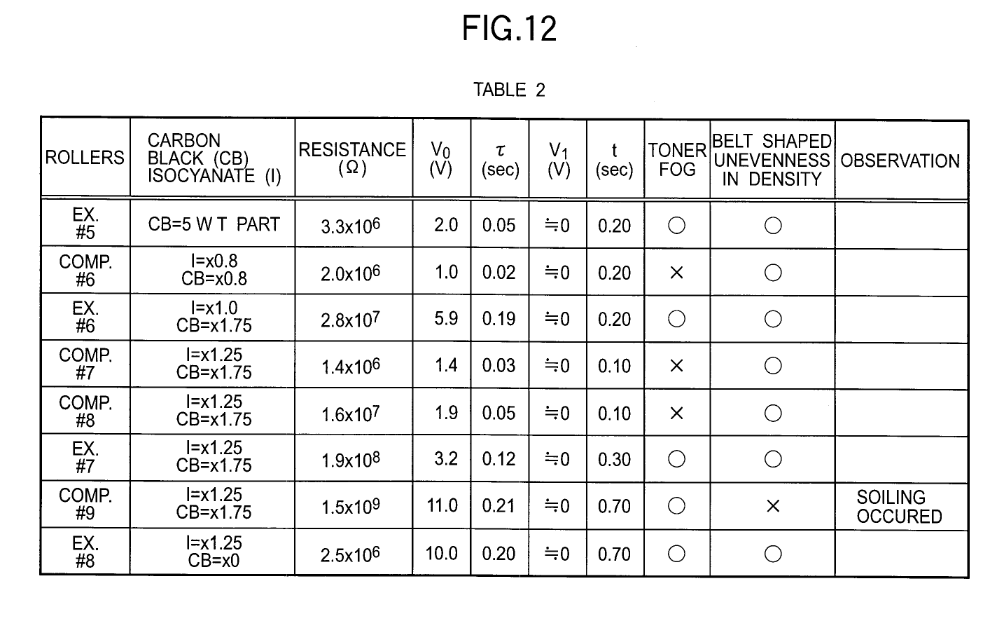

The developing roller 28 according to the present invention provides advantages in which belt-shaped unevenness in density and toner fog can be minimized by lowering the dielectric characteristic of the developing roller 28. The specific test results of belt-shaped unevenness in density and toner fog will now be described with reference to Table 1 shown in FIG. 12.

By using the image forming apparatus 1, a test pattern having an area density of 0.3% was printed on a total of 1000 pages of A4 size recording medium 4, and the image forming apparatus was then powered down and was left for 24 hours. The image forming apparatus was powered up again after 24 hours, and the test pattern as shown in FIG. 9B was printed at a resolution of 600 dpi. The test pattern is a matrix of 2-by-2-dot areas aligned at four-dot center-to-center intervals in a first direction and in a second direction perpendicular to the first direction. Each of the 2-by-2-dot areas contains two consecutive dots in the first direction and two consecutive dots in the second direction perpendicular to the first direction. By using the FIG. 9B test pattern printed after the image forming apparatus 1 was powered on again, evaluation was made to check for belt-shaped unevenness in density. Evaluation was made to check for toner fog on the surface of the photoconductive drum 21 by measuring a color difference ΔE of the toner adhered to the mending tap.

The belt-shaped unevenness in density and toner fog will be described specifically.

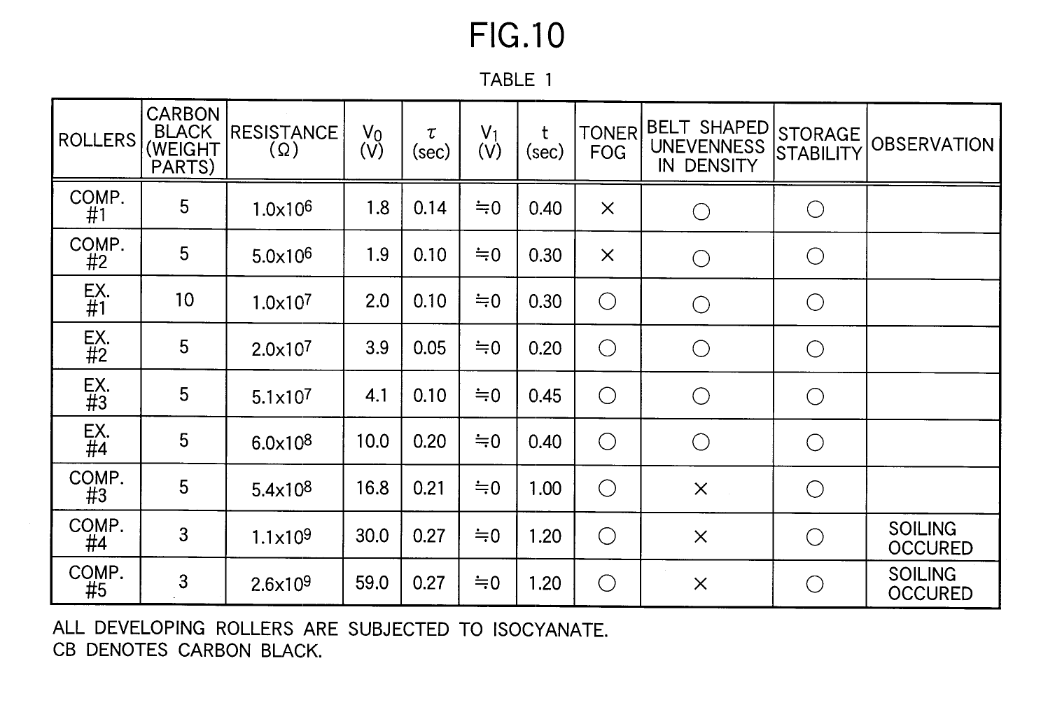

FIG. 10 illustrates Table 1 that shows test results of belt-shaped unevenness in density and toner fog of the developing roller.

Symbols in Table 1 will be described. The surfaces of all of the developing rollers 28 have been subjected to an isocyanate treatment. Symbol “◯” denotes that no uneven density in the shape of a belt occurred in the printed image when the 2×2 test pattern is printed. Symbol “×” denotes that an uneven density in the shape of a belt occurred in the printed image when the 2×2 test pattern (FIG. 9B) is printed. Likewise, symbol “◯” denotes that no toner fog was observed in the printed images under a condition of ΔE<1.5. Symbol “×” denotes that toner fog was observed in the printed images under the condition of ΔE≧1.5. Carbon black in weight parts shown in Table 1 is the amount of carbon black contained in a surface layer of the developing roller.

Referring to Table 1, belt-shaped unevenness in density was observed (symbol “×”) in COMPARISONs #3, 4, and 5 in which the relaxation time τ is longer than 0.20 seconds. It is to be noted that the higher the dielectric characteristic of the developing roller 28 is, the longer the relaxation time τ is, so that belt-shaped unevenness in density is dominant. Toner fog was observed (symbol “×”) in COMPARISONs #1 and #2 in which the surface potential Vo is lower than 2.0 V. COMPARISONs #1 and #2 have not been subjected to IPA cleaning. COMPARISONs #3-#5 and Examples #1 to #4 have been subjected to IPA cleaning. Toner fog was not observed (symbol “◯”) in COMPARISONs #4 and #5 in which the surface potential Vo is equal to or higher than 30.0 V but soling was observed in the printed image since the amount of charge on the toner 24 was over a certain level. Thus, there is a certain correlation between the surface potential Vo and the charging property of the toner 24, i.e., toner fog occurs if Vo is lower than a certain level, and soiling occurs if Vo is higher than the certain level. When printing is performed a month after the developing unit 2 has been left in an environment of 50° C. and 55% RH, none of COMPARISONs and EXAMPLEs showed a cake of the toner 24 on the developing roller 28 and soiling on the photoconductive drum 21. Although, the developing rollers 28 in EXAMPLEs #1 to #4 and COMPARISONs #1 to #5 contain a substantially equal amount of carbon black, the resistance of the developing roller 28, (i.e., the resistance between the metal shaft and the surface of the developing roller) exhibits variations due to manufacturing variations. However, the variations in resistance do not affect the evaluation of belt-shaped unevenness in density and toner fog.

The toner 24 used in the evaluation was a pulverized, one component non-magnetic toner having a volume mean particle diameter of 5.7 μm and a toner blow-off charge of −43 μC/g. However, equivalent effects were obtained by using a pulverized, one component non-magnetic toner having a volume mean particle diameter in the range of 5.3 to 6.1 μm and a toner blow-off charge in the range of −40 to −60 μC/g. Since the total surface area of the toner 24 per unit weight is limited by the volume mean particle diameter of the toner 24, larger particle diameters of the toner 24 cause larger values of Q/M, i.e., the amount of charge per unit weight of the toner. Therefore, the smaller the particle diameter of the toner 24 is, the larger the amount of charge on the toner 24 is, so that the belt-shaped unevenness in density tends to occur. A pulverized, one component non-magnetic toner having a volume mean particle diameter of 8 μm and a toner blow-off charge of −20 μC/g did not cause belt-shaped unevenness in density.

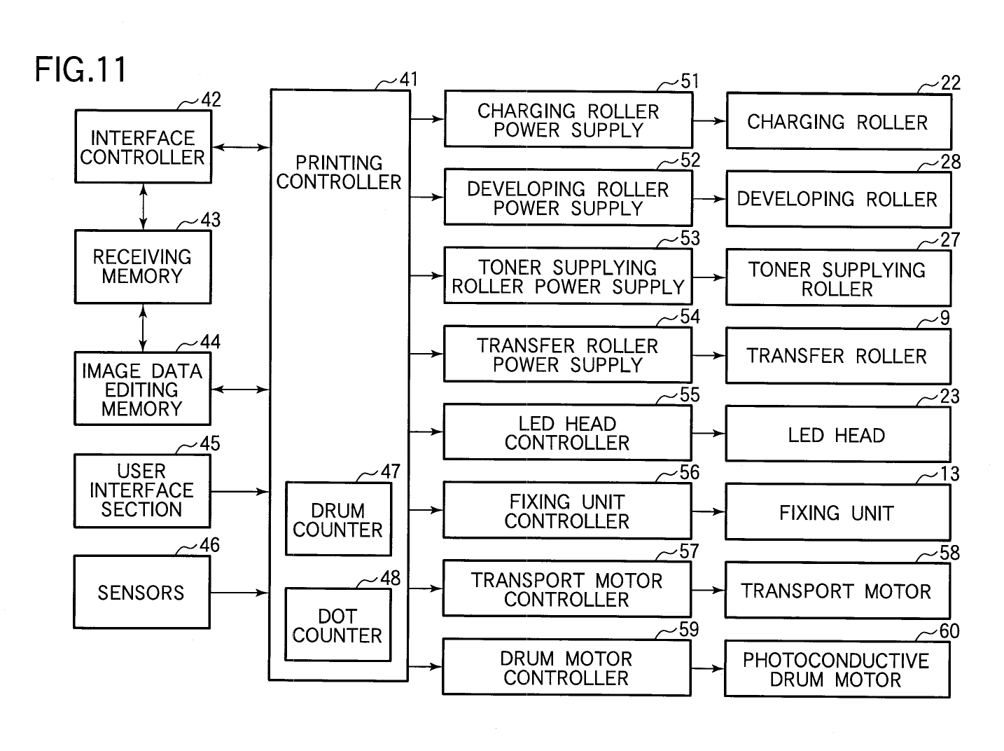

The control of the above-described image forming apparatus 1 will be described with reference to FIG. 11.

FIG. 11 is a block diagram illustrating the configuration of the image forming apparatus 1.

The image forming apparatus 1 includes a printing controller 41 that generally includes a microprocessor, a ROM, a RAM, an input/output pot, and a timer. The printing controller 41 provides commands to the respective sections to control a series of developing processes for printing images on the recording medium 4.

The printing controller 41 is connected to the following sections. An interface controller 42 controls the reception of data and control commands from a host apparatus (not shown). A receiving memory 43 stores print data received through the interface controller 42. An image data editing memory 44 stores the image data obtained by editing the print data. A user operates a user interface section 45 to control the image forming apparatus 1. Sensors 46 monitor the operation statuses of the image forming apparatus 1. A charging roller power supply 51 supplies a high voltage to the charging rollers 22. A developing roller power supply 52 supplies a high voltage to the developing rollers 28. A toner supplying roller power supply 53 supplies a high voltage to the toner supplying rollers 27. A transfer roller power supply 54 supplies a high voltage to the transfer rollers 9. An LED head controller 55 controls LED heads 23. A fixing unit controller 56 controls the fixing unit 13. A transport motor controller 57 controls a transport motor 58. A drum motor controller 59 controls a photoconductive drum motor 60. A drum counter 47 counts the cumulative number of rotations of the photoconductive drum 21. A dot counter 48 counts the cumulative number of printed dots.

The printing controller 41 of the above-described configuration controls the overall sequence of the operation of the image forming apparatus 1 in accordance with the data and control commands received from the host apparatus, thereby performing a printing operation. The respective sections connected to the printing controller 41 will be described with reference to FIG. 11. Reference should be made to the details described with reference to FIGS. 1 and 2 for remaining structural elements.

The interface controller 42 controls the reception of the data and control commands from the host apparatus (not shown) in response to a command from the printing controller 41. The receiving memory 43 is a read/write volatile memory that temporarily stores the print data, which is received through the interface controller 42 from the host apparatus, in response to a command from the printing controller 41. The image data editing memory 44 is a read/write volatile memory. In response to a command from the printing controller 41, the image data editing memory 44 receives the print data from the receiving memory 43, edits the print data into image data, and then the temporarily stores the image data. The user interface section 45 includes a display that displays the operational statuses of the image forming apparatus 1 to the user, and switches operated by the user to control the image forming apparatus 1. The sensors 46 includes a variety of switches and sensors such as paper position sensors, a temperature sensor, a humidity sensor, and a print density sensor, all of which monitoring the operation of the image forming apparatus 1 at all times while the image forming apparatus 1 remains powered up.

The charging roller power supply 51 applies a predetermined high voltage to the charging roller 22 in response to a command from the print controller 41, thereby charging the surface of the photoconductive drum 21. The developing roller power supply 52 applies a predetermined high voltage to the developing roller 28, which deposits the toner 24 to the electrostatic latent image formed on the photoconductive drum 21, in response to a command from the printing controller 41. The transfer roller power supplying 54 applies a predetermined high voltage to the transfer rollers 9, which transfers the toner image formed on the photoconductive drum 21 onto the recording medium 4. The voltage applied to the transfer rollers 9 has the opposite polarity to that applied to the photoconductive drums 21.

The LED head controller 55 receives image data from the image data editing memory 44, and then drives LED heads 23 to illuminate the surface of the photoconductive drums 21 to form electrostatic latent images on the photoconductive drums 21. The fixing unit controller 56 controls the fixing unit 13 constituted of the fixing roller 14 and the pressure roller 15. The transport motor controller 57 controls the transport motor 58, which drives the transport rollers 32, 33, 34, and 37, in response to a command from the print controller 41, thereby transporting and/or halting the recording medium 4. The drum motor controller 59 controls the photoconductive drum motor 60, which drives the photoconductive drum 21 in rotation, so that the toner image is transferred onto the recording medium 4. The drum counter 47 counts the cumulative number of rotations of the photoconductive drum 21 while the dot counter 48 counts the cumulative number of dots in the image data for one page of the recording medium 4 edited in the image data editing memory 44.

As described above, when a voltage of 6,000 V is applied to the developing roller 28 from a distance of 1 mm from the surface of the developing roller 28 to cause a corona discharge to take place, the developing roller 28 satisfies the following relationship:

2.0≦Vo≦10 (1)

0<τ<0.20 (2)

where Vo (volts) is the surface potential of the developing roller 28 0.15 seconds after charging, and τ (seconds) is a relaxation time during which the surface potential of the developing roller 28 changes from Vo to Vo/e. Thus, even if printing is performed to print an image on a sheet of medium after a certain period of time during which the image forming apparatus remains inoperative, image data can still be transferred onto the recording medium 4 with a small difference in the resistance and surface potential between the exposed surface 28D in contact with the outside air and the toner-receiving surface 28C in contact with the bulk toner, thereby alleviating occurrence of belt-shaped unevenness in density and toner fog in printed images. The surface of the developing roller 28 is subjected to the isocyanate treatment, thereby preventing the toner 24 from becoming caked at the nip between the photoconductive drum 21 and the developing roller 28 even if printing is performed to print an image on a sheet of medium after a certain period of time during which the image forming apparatus remains inoperative. This improves storage stability of the developing sub units 2C, 2Y, 2M, and 2K and the image forming apparatus 1.

### Second Embodiment

A developing roller according to a second embodiment is manufactured by subjecting the surface of the developing roller to urethane treatment, thereby minimizing the change in the resistance of the developing roller with increasing cumulative number of printed pages as opposed to the developing roller according to the first embodiment that is subjected to isocyanate treatment. Just as in the developing roller 28 according to the first embodiment, the second embodiment makes it possible to develop the electrostatic latent image with small differences in the changes of the resistance and the surface potential of the developing roller between an exposed surface (28D shown in FIG. 3) in contact with outside air and a tone-receiving surface (28C shown in FIG. 3) in contact with the toner even if printing is performed to print an image on a sheet of medium after a certain period of time during which the image forming apparatus remains inoperative.

The developing roller according to the second embodiment will be described. The configuration of the image forming apparatus according to the second embodiment is substantially the same as that of the first embodiment except for the developing roller 28. Thus, a description will be given mainly of the developing roller 28 with reference to Table 2 (FIG. 12).

The surface of the developing roller 28 is subjected to urethane treatment as follows:

An isocyanate solution is prepared by mixing 20 weight parts isocyanate compound and 100 weight parts acetic ether. Urethane prepolymer is then added to the isocyanate solution for reaction, thereby obtaining a urethane solution. The developing roller 28 is immersed for 30 seconds in the urethane solution, and is left for 10 hours in an oven of 100° C. to dry.

FIG. 12 illustrates Table 2 that shows test results of belt-shaped unevenness in density and toner fog of the developing roller. The belt-shaped unevenness in density and toner fog of the developing roller will now be specifically described with respect to Table 2. The test results were evaluated just as in the first embodiment. Symbols I denote the amount of isocyanate and symbol CB denoted the amount of carbon. All of EXAMPLES and COMPARISONs have been subjected to urethane treatment. Carbon black in weight parts shown in Table 2 is the amount of carbon black contained in a surface layer of the developing roller. The amount of isocyanate for COMPARISONs #6-#9 and EXAMPLEs #6-#8 are shown as a ratio to that (i.e., 20 weight parts) for EXAMPLE #5.

Referring to Table 2, COMPARISON #9 having a relaxation time τ of 0.20 seconds shows poor belt-shaped unevenness in density (denoted by “×”). A higher dielectric characteristic of the developing roller 28 tends to cause a longer relaxation time τ, which in turn causes prominent belt-shaped unevenness in density. COMPARISONs #6-#8 having surface potentials Vo lower than 2.0 V shows poor toner fog. COMPARISON #9 having a surface potential Vo higher than 30.0 V shows good toner fog but a printed test pattern was soiled since the amount of charge on the toner 24 exceeds a certain value. Thus, there is a certain correlation between the surface potential Vo and the charging property of the toner 24, that is, the surface potential Vo less than a certain value tends to cause toner fog and the surface potential Vo higher than the certain value tends to cause soiling in printed images. Because the developing rollers for the respective COMPARISONs and EXAMPLEs are not manufactured with an equal amount of isocyanate and an equal amount of carbon black, the developing rollers exhibit variations in their resistance. However, such variations in resistance will not affect the test results.

The toner 24 used in the second embodiment is a pulverized, one component non-magnetic toner having a volume mean particle diameter of 5.7 μm and a toner blow-off charge of −43 μC/g. Also, belt-shaped unevenness in density and toner fog were equally minimized when a pulverized, one component non-magnetic toner having a volume mean particle diameter in a range of 5.3 to 6.1 μm and a blow-off charge in a range of −40 to −60 μC/g was used. A total surface area per unit weight of the toner 24 is limited by its volume mean particle diameter. Thus, the value of blow-off charge (Q/M) increases with increasing volume mean particle diameter. The smaller the particle diameter of the toner 24 is, the larger the amount of charge on the toner 24 so that belt-shaped unevenness in density tends to occur. A pulverized, one-component non-magnetic toner having a volume mean particle diameter of 8 μm and a blow-off charge of −20 μC/g did not cause belt-shaped unevenness in density.

The developing roller that has undergone urethane treatment shows a smaller increase in resistance as the number of printed pages increases than the developing roller that has undergone isocyanate treatment. Specifically, the developing roller that has undergone isocyanate treatment shows an increase in resistance by two or three orders of magnitude after having printed 10,000 pages of the recording medium 4 while the developing roller 28 that has undergone urethane treatment shows an increase in resistance only by one order of magnitude after printing of 10,000 pages of the recording medium 4. The above-described effects are considered due to the fact that an isocyanate treatment solution penetrates in greater depth into the elastic layer for the developing roller 28 that has undergone urethane treatment than for the developing roller that has undergone urethane treatment. In other words, the urethane solution penetrated into the elastic layer does not cut the electrically conductive structure of carbon black significantly, thereby minimizing the change in resistance of the developing roller over time. Thus, the developing roller 28 that has undergone the urethane treatment can minimize the change in resistance over time more greatly than the developing roller 28 that has undergone the isocyanate treatment.

As described above, when a voltage of 6,000 V is applied to the developing roller 28 from a distance of 1 mm from the surface of the developing roller 28 to cause a corona discharge to take place, the developing roller 28 satisfies the following relationship:

2.0≦Vo≦10 (1)

0<τ≦0.20 (2)

where Vo (volts) is the surface potential of the developing roller 28 0.15 seconds after the charging, and τ (seconds) is a relaxation time during which the surface potential of the developing roller 28 changes from Vo to Vo/e. Thus, even if printing is performed to print an image on a sheet of medium after a certain period of time during which the image forming apparatus remains inoperative, image data can be transferred onto the recording medium 4 with small differences in the resistance and surface potential between the exposed surface 28D in contact with the outside air and the toner-receiving surface 28C in contact with the bulk toner, thereby alleviating belt-shaped unevenness in density and toner fog in printed images. The change in resistance of the developing roller 28 over time as the number of printed pages increases can be minimized by subjecting the surface of the developing roller 28 to urethane treatment.

The first and second embodiments have been described in terms of a printer, the invention may also be applied to copying machines, facsimile machines, and multi function printers (MFPs).

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A developer material carrying body in contact with an image carrying body on which an electrostatic latent image is formed, and depositing a developer material to the electrostatic latent image, the developer material carrying body comprising:
a surface configured to be charged to a predetermined surface potential; and
a relaxation time (τ) required for the predetermined surface potential to change from a first value (Vo) of the surface potential to a second value (Vo/e) of the surface potential, the second value being given by the first value divided by the base of natural logarithm (e);
wherein the surface potential and the relaxation time (τ) are related such that
2.0≦Vo≦10
0<τ≦0.20
where Vo is the first value in volts of the surface potential 0.15 seconds after the developer carrying body has been charged, and τ is the relaxation time in seconds required for the surface potential to change from the first value (Vo) to the second value (Vo/e).

2. The developer material carrying body according to claim 1, wherein the surface of the developer material carrying body has undergone isocyanate treatment.

3. The developer material carrying body according to claim 1, wherein the surface of the developer material carrying body has undergone urethane treatment.

4. A developing device incorporating the developer material carrying body according to claim 1.

5. A developing device incorporating the developer material carrying body according to claim 2.

6. A developing device incorporating the developer material carrying body according to claim 3.

7. An image forming apparatus incorporating the developer material carrying body according to claim 4.
